(19) United States
(12) Patent Application Publication
(10) Pub. No.: US 2019/0024753 A1
(43) Pub. Date: Jan. 24, 2019

(54) Torsional Vibration Damping Assembly For A Drive Train Of A Vehicle

(71) Applicant: ZF Friedrichshafen AG, Friedrichshafen (DE)

(72) Inventors: Andreas ORLAMÜNDER, Schonungen (DE); Daniel LORENZ, Bad Kissingen (DE); Thomas DÖGEL, Nuedlingen (DE); Kyrill SIEMENS, Wuerzburg (DE); Erwin WACK, Niederwerrn (DE); Tobias DIECKOFF, Wuerzburg (DE); Markus TERWART, Thundorf (DE); Matthias REISCH, Ravensburg (DE); Matthias ARZNER, Friedrichshafen (DE)

(21) Appl. No.: 16/070,793

(22) PCT Filed: Dec. 19, 2016
(86) PCT No.: PCT/EP2016/081659

§ 371 Date: Jul. 18, 2018

(30) Foreign Application Priority Data
Jan. 22, 2016 (DE) 10 2016 200 906.0

(51) Int. Cl. F16F 15/167; F16F 15/16

(52) U.S. Cl. CPC F16F 15/167; F16F 15/162

(57) ABSTRACT

A torsional vibration damping arrangement for a drivetrain of a vehicle includes a rotational mass arrangement which is rotatable around a rotational axis. The rotational mass arrangement includes a primary inertia element which is rotatable around rotational axis A and a secondary inertia element which is rotatable relative to the primary inertia element against the action of an energy storage and further includes a displacer unit with a working chamber. The displacer unit is operatively connected to the primary inertia element or to the secondary inertia element on one side and to a damper mass on the other side.

### PRIORITY CLAIM

This is a U.S. national stage of application No. PCT/EP2016/081659, filed on Dec. 19, 2016. Priority is claimed on the following application: Country: Germany, Application No.: 10 2016 200 906.0, filed: Jan. 22, 2016, the content of which is/are incorporated in its entirety herein by reference.

### FIELD OF THE INVENTION

The present invention is directed to a torsional vibration damping arrangement for a drivetrain of a vehicle, comprising a primary side to be driven in rotation around a rotational axis and a secondary side which is coupled with the primary side via a working medium for rotation around the rotational axis and for relative rotation with respect to one another.

### BACKGROUND OF THE INVENTION

A torsional vibration damping arrangement of this kind is known from US published application US-2010-0090382-A1. This known torsional vibration damping arrangement has a primary side and a secondary side which is coupled with the primary side via a damper fluid arrangement for rotation around a rotational axis and for relative rotation with respect to one another. The damper fluid arrangement comprises, in a first damper fluid chamber arrangement, a first damper fluid with less compressibility which transmits a torque between the primary side and the secondary side and comprises, in a second damper fluid chamber arrangement, a second damper fluid which has greater compressibility and which is loaded during a pressure increase of the first damper fluid in the first damper fluid chamber arrangement. The second damper fluid chamber arrangement comprises a plurality of preferably substantially cylindrical chamber units which are arranged radially outwardly and/or radially inwardly with respect to the first damper fluid chamber arrangement and successively in circumferential direction. A separating element which separates the first damper fluid from the second damper fluid and which is substantially radially displaceable when there is a change in pressure in the chamber unit is associated with each chamber unit. The advantage of this vibration reducing system consists in that the stiffness can be adjusted substantially as low as required, which enables a very good decoupling of the torsional vibrations of the internal combustion engine. However, the disadvantage is that the torsional vibrations cannot be reduced sufficiently in a simple coupled oscillator in spite of the lowest possible stiffness because, even when reduced to close to zero, a side shaft stiffness in the vehicle associated with the rest of the drivetrain defines the vibrational behavior of the entire drivetrain.

It is thus an object of the present invention to provide a torsional vibration damping arrangement for a drivetrain in a vehicle with which an efficient reduction of torsional vibrations in the torque transmitted in a drivetrain can be achieved in a compact construction and with a low mass moment of inertia.

### SUMMARY OF THE INVENTION

According to the invention, this object is met through a torsional vibration damping arrangement for a drivetrain of a vehicle, comprising a rotational mass arrangement which is rotatable around a rotational axis A. The rotational mass arrangement comprises a primary inertia element which is rotatable around rotational axis A and a secondary inertia element which is rotatable relative to the primary inertia element against the action of a stiffness and further comprises a displacer unit with a working chamber. The displacer unit is operatively connected to the primary inertia element or to the secondary inertia element on one side and to a damper mass on the other side. The primary inertia element and the secondary inertia element which is rotatable against the stiffness are constructed in a manner comparable to a dual mass flywheel. The stiffness can be constructed in this instance in the form of an energy storage, especially a gas spring or an elastically deformable element such as a steel spring. On the one side, the slave cylinder which advantageously includes a housing element, a displacer piston and a working chamber is connected, for example, to the housing element with the primary inertia element or the secondary inertia element. Further, the displacer piston of the displacer unit is connected to a damper mass. The working chamber of the displacer unit is operatively connected by a connection line and via a rotary feedthrough to a working chamber of a pressure storage which is rotatable around rotational axis A through a working medium, in this case advantageously a hydraulic fluid. An energy storage of the pressure storage can be constructed in the form of a gas spring or in the form of an elastically deformable element. When the displacer unit is fastened to the secondary inertia element, the manner of functioning is as follows: a torque with the torsional vibrations contained therein is conveyed to the primary mass inertia element from a drive unit, for example, an internal combustion engine. The torque with the torsional vibrations arrives at the secondary inertia element via the energy storage. The torsional vibrations generate a fluid pressure in the working medium in the working chamber of the displacer unit because the displacer piston is in turn supported against the damper mass.

The working medium, for example, hydraulic fluid, further conveys the fluid pressure via the connection line to the working chamber of the pressure storage which is supported by a displacer piston against the gas spring or against a steel spring, for example. This results in reduced vibrations, and the pressure storage does not participate in rotation around the rotational axis A and therefore is not included in the mass inertia element of the rotational mass arrangement, which is advantageous for a response behavior of the internal combustion engine. In this way also, a change in the pressure storage can advantageously be carried out from the outside, i.e., not at the rotating parts of the torsional vibration damping arrangement, so that existing torsional vibrations can be variably influenced and an influence can therefore be exerted on the reduction of these torsional vibrations. A supply pump can advantageously be connected to the working medium for leakage compensation and/or so as to exert influence on the pressure level in the working medium and therefore on the vibration damping behavior.

In a further configuration, a stiffness arrangement acts in parallel with or in series with the working direction of the displacer unit between the damper mass and the primary inertia element or between the damper mass and the secondary inertia element. The stiffness arrangement is advantageously formed of a gas spring or an elastically deformable element, for example, a steel spring.

A further advantageous embodiment form provides that the working chamber of the displacer unit is operatively connected by a connection line to an external working chamber of a pressure storage, which working chamber is fixed with respect to rotation relative to the rotational axis A. As has already been described, the working medium, for example, the hydraulic fluid, is conveyed from the working chamber of the displacer unit to the working chamber of the pressure storage via the connection line. The pressure storage comprises especially the working chamber and a housing element and a displacer piston.

Further, the pressure storage comprises an energy storage which is an elastically deformable element or a pneumatically compressible element. The energy storage acts opposite the working direction of the fluid pressure of the hydraulic fluid.

As has already been mentioned, the working medium between the displacer unit and the pressure storage can be a viscous medium, a gas, or a combination of a viscous medium and a gas.

A further advantageous embodiment form provides that the connection line has a rotary feedthrough which rotatably connects the displacer unit, which is rotatable around rotational axis A, and the pressure storage, which is fixed with respect to rotation relative to the rotational axis A, so as to be liquid-tight and/or gas-tight and so as to be rotatable with respect to one another.

In a further configuration, the displacer unit comprises a load spring element which acts opposite a working direction of a change in volume V1 of the working chamber of the displacer unit. This can make possible an additional shift of the operating point of the effective damper stiffness by increasing the fluid pressure of the working medium in the displacer unit and in the pressure storage against the load spring. This load spring can be constructed as a steel spring or as a gas spring. By the alternating torque at the displacer, excitation is carried out via the alternating pressure on the damper mass arrangement comprising the damper mass and the damper stiffness arrangement. When suitably tuned, the damper mass arrangement acts in phase opposition and accordingly at least partially eliminates vibrations. For example, the system can be tuned in a speed-adaptive or order-adaptive manner, or both, for example, during cylinder shut-off from the second order in four-cylinder operation to the first order in two-cylinder operation.

A further embodiment provides that the pressure storage comprises a supply pump and/or a control unit, and the supply pump and/or the control unit are/is operatively connected to the working medium of the working chamber of the pressure storage. This can be advantageous, for one, to compensate for leakage and/or to achieve a load point shift of the damper mass arrangement. For this purpose, the pressure of the working medium can be changed by the supply pump and the pressure storage. The control unit which can control the needed pressure of the working medium can also be advantageous for this purpose. The supply pump can advantageously be an oil pressure pump or a compressor. The control unit advantageously includes sensors for detecting pressure, pressure control valves and pressure switching valves.

A further advantageous embodiment provides that the stiffness arrangement of the damper subassembly comprises an energy storage which is constructed as an elastically deformable element or a pneumatically compressible element.

A further embodiment provides that the energy storage between the primary inertia element and the secondary inertia element is an elastically deformable element or a pneumatically compressible element.

### BRIEF DESCRIPTION OF THE DRAWINGS

The present invention will be described in detail in the following with reference to the accompanying figures, in which:

FIG. 1 is a schematic view of a torsional vibration damping arrangement with a rotational mass arrangement comprising a damper subassembly with a stiffness which is connected in series with a displacer and which is rotatable around a rotational axis A;

FIG. 2 is a schematic view of a torsional vibration damping arrangement such as that in FIG. 1, but with a stiffness which is connected in parallel with the displacer unit and which is rotatable around rotational axis A and with a gas spring as stiffness arrangement;

FIG. 3 is a schematic view of a torsional vibration damping arrangement such as that in FIG. 1, but with an external stiffness in the form of a pressure storage which is not rotatable around the rotational axis A;

FIG. 4 is a schematic view of a torsional vibration damping arrangement such as that in FIG. 1, but with a load spring element in the displacer element;

FIG. 5 is a schematic view of a torsional vibration damping arrangement such as that in FIG. 1, but with the stiffness arrangement between the damper mass and the primary inertia element; and

FIG. 6 is a schematic view of a torsional vibration damping arrangement such as that in FIG. 2, but with the stiffness arrangement between the damper mass and the primary inertia element.

### DETAILED DESCRIPTION OF THE PRESENTLY PREFERRED EMBODIMENTS

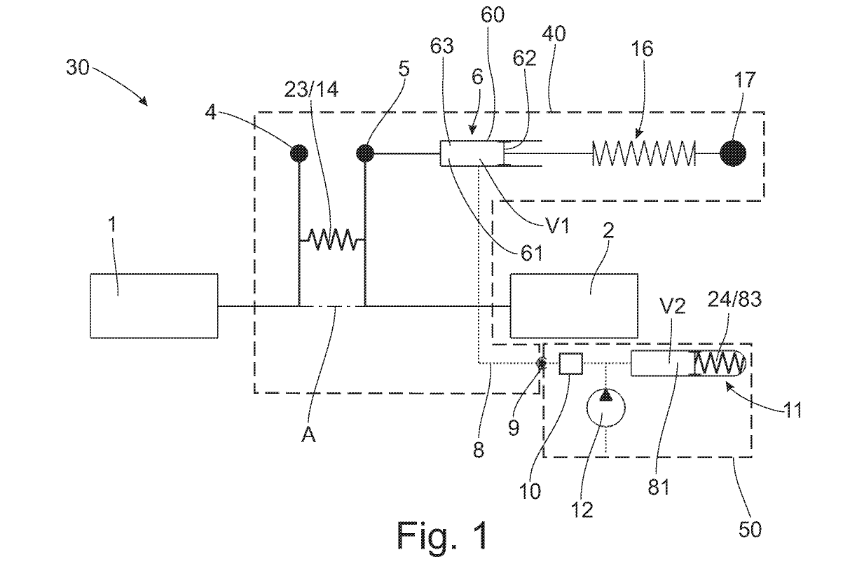

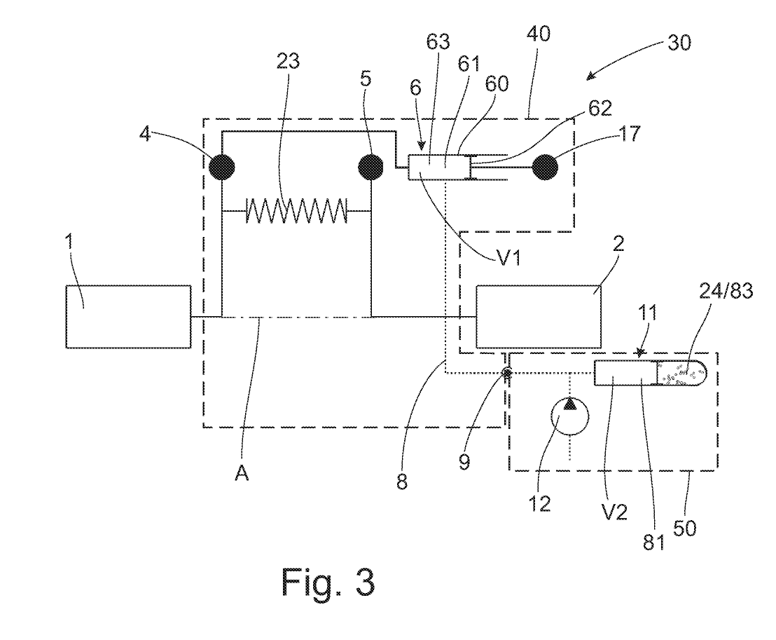

FIG. 1 shows a torsional vibration damping arrangement 30 which is installed between a drive unit 1 and a transmission unit 2. In the present case, the torsional vibration damping arrangement 30 principally comprises a rotational mass arrangement 40 which is rotatable around the rotational axis A and a damping arrangement 50 which is not rotatable around rotational axis A but, rather, is positioned in a stationary manner, for example, in a trunk compartment of a motor vehicle, not shown. The rotational mass arrangement 40 in the present instance comprises a primary inertia element 4 and a secondary inertia element 5 which are both rotatable relative to one another against a fixed stiffness 14, in this case a steel spring. The rotational mass arrangement 40 further comprises a displacer unit 6 which includes, inter alia, a housing element 60, a displacer piston 62 and a working chamber 61 with a volume V1. The housing element 60 of the displacer unit 6 is connected to the secondary inertia element 5 and the displacer piston 62 by a stiffness arrangement 16 with a damper mass 17. These component parts are rotatable around rotational axis A and constitute the part of the torsional vibration damping arrangement 30 that rotates around the rotational axis A. Further, the working chamber 61 of the displacer unit 6 is connected via a connection line 8 and a rotary feedthrough 9 to a working chamber 81 of a pressure storage 11 of the damping arrangement 50. Damping arrangement 50 and, therefore, also pressure storage 11 constitute the part of the torsional vibration damping arrangement 30 that is not rotatable around rotational axis A. Pressure storage 11 further comprises a displacer piston which separates working chamber 81 from an energy storage 24, in this case a pneumatically compressible element 83 shown in FIG. 3. The torsional vibration damping arrangement 30 functions in the following manner: A torque with the torsional vibrations contained therein is conveyed from the drive unit 1, for example, an internal combustion engine, to the primary inertia element 4 and, via the fixed stiffness 14, to the secondary inertia element 5 and subsequently to a transmission unit 2. The secondary inertia element 5 is connected to the housing element 60 of the displacer unit 6. The existing torsional vibrations, also referred to as alternating torques, are transformed in the working chamber 61 of the displacer unit 6 into an alternating pressure which is conveyed via a working medium 63, in this case, a hydraulic fluid, for example, to the working chamber 81 of pressure storage 11 via connection line 8 and rotary feedthrough 9.

A pneumatically compressible element 83, for example, a gas spring as shown in FIG. 3, opposes the alternating pressure in the working chamber as stiffness. The damper subassembly 20 which is connected to the displacer piston 62 of the displacer unit 6 serves as vibration damping.

Further, a supply pump 12, for example, an oil pressure pump, is connected to the working medium 63 and serves to compensate leakage or to actively superpose a periodic pressure characteristic which preferably acts in phase opposition. However, this requires a control unit 10 which is operatively connected to the working medium 63 and can influence the pressure of the working medium.

It should be noted that the displacer unit 6 with the associated damper subassembly 20 can also be connected to the primary inertia element instead of to the secondary inertia element. In other respects, the foregoing remarks apply.

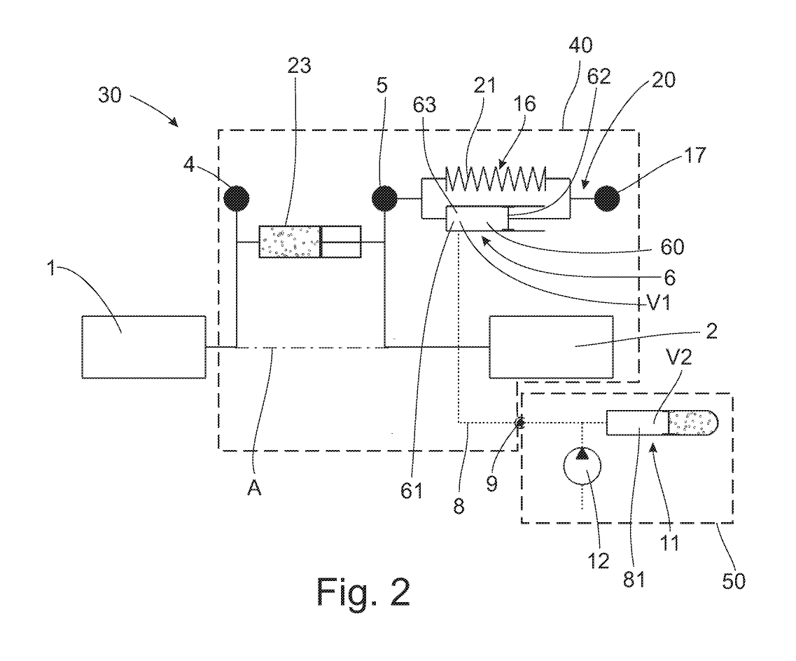

FIG. 2 shows a torsional vibration damping arrangement 30 such as that shown in FIG. 1 but with a stiffness arrangement 16 connected in parallel with the displacer unit 6 and rotatable around rotational axis A. For the further description of FIG. 2, reference is had to FIG. 1.

FIG. 3 shows a torsional vibration damping arrangement 30 such as that described referring to FIG. 1 but with only an external stiffness in the form of a pressure storage 11 which is not rotatable around rotational axis A. The stiffness arrangement 16 from FIG. 1 or 2 which is rotatable around rotational axis A is omitted in this embodiment form. Otherwise, reference is had again to the description of FIG. 1.

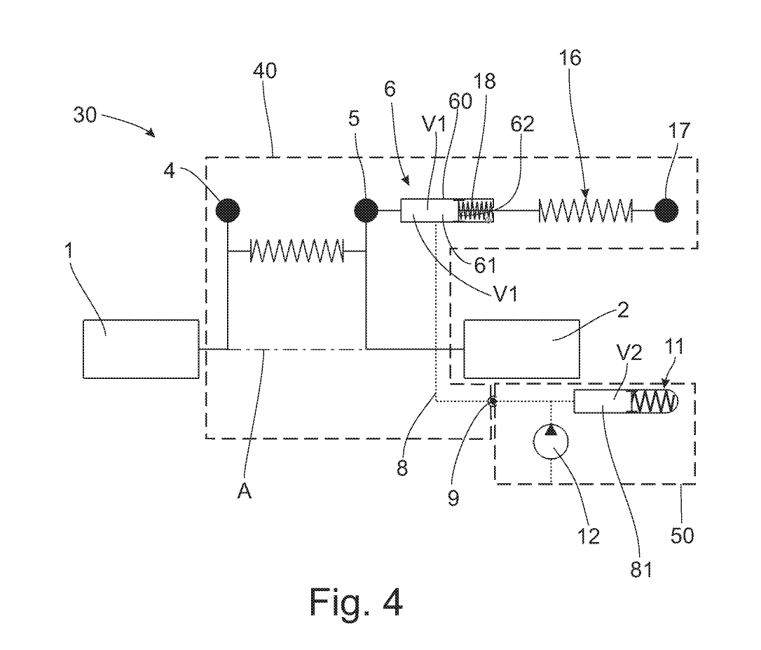

FIG. 4 shows a torsional vibration damping arrangement such as that described referring to FIG. 1 but with a load spring element 18 in the displacer unit 6 acting in opposition to the fluid pressure in working chamber 61 of displacer unit 6. By an increase in pressure through supply pump 12 against load spring element 18, the damper stiffness can be adapted, for example, to the speed or order or both, for example, during cylinder shut-off from the second order in four-cylinder operation to the first order in two-cylinder operation. Otherwise, reference is again had to the description of FIG. 1.

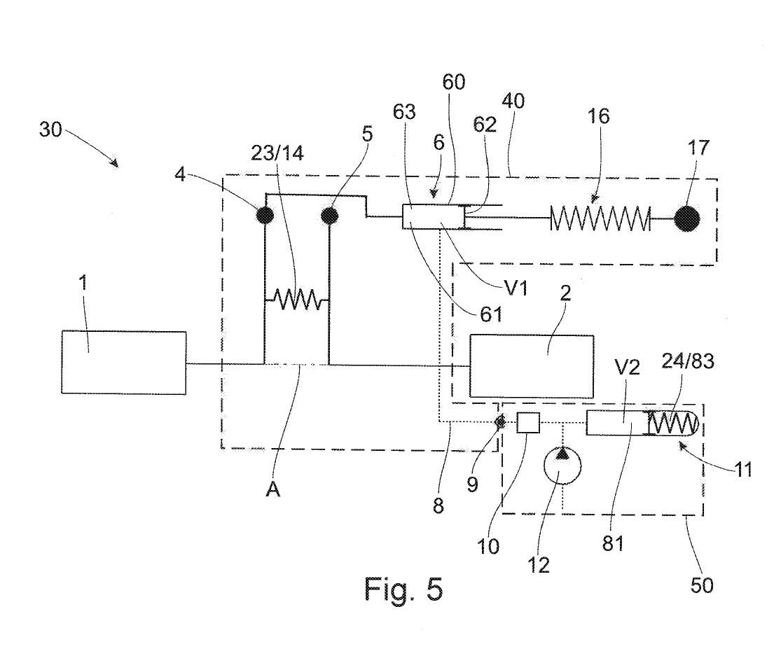

FIG. 5 is a schematic view of a torsional vibration damping arrangement such as that in FIG. 1, but with the stiffness arrangement 16 in series with the displacer unit 6 and disposed between the damper mass 17 and the primary inertia element 4. Otherwise, reference is had again to the description of FIG. 1.

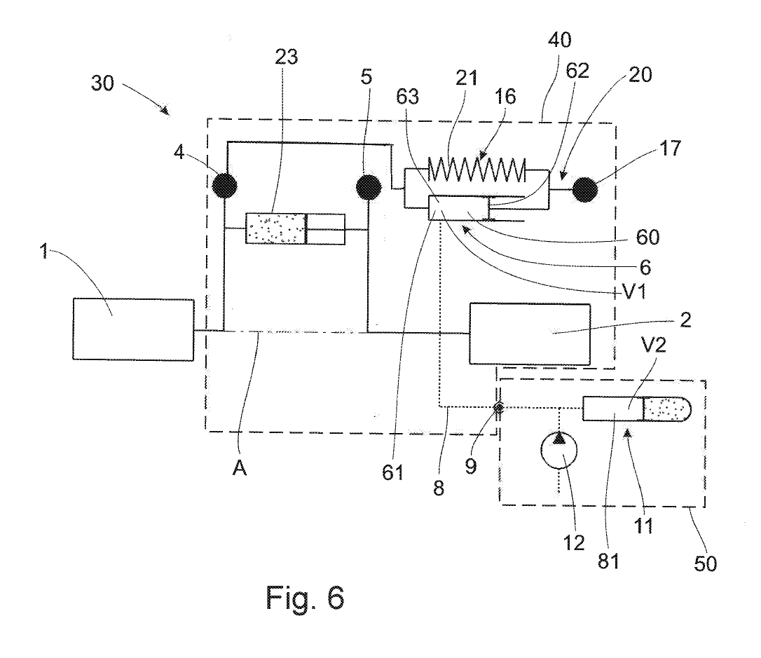

FIG. 6 is a schematic view of a torsional vibration damping arrangement such as that in FIG. 2, but with the stiffness arrangement 16 in parallel with the displacer unit 6 and disposed between the damper mass 17 and the primary inertia element. Otherwise, reference is had again to the description of FIG. 2.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-10. (canceled)

11. A torsional vibration damping arrangement for a drivetrain of a vehicle, comprising:
a rotational mass arrangement rotatable around a rotational axis A; the rotational mass arrangement comprising a primary inertia element rotatable around the rotational axis A and a secondary inertia element rotatable relative to the primary inertia element against the action of a first energy storage;
a displacer unit having a working chamber and a working direction, and wherein a side of the displacer unit is operatively connected to the primary inertia element or to the secondary inertia element and another side of the displacer unit is operatively connected to a damper mass.

12. The torsional vibration damping arrangement according to claim 11, additionally comprising a stiffness arrangement acting in parallel with or in series with the working direction of the displacer unit between the damper mass and the primary inertia element or between the damper mass and the secondary inertia element.

13. The torsional vibration damping arrangement according to claim 11, wherein the working chamber of the displacer unit is operatively connected by a connection line containing a working medium to an external working chamber of a pressure storage, the working chamber fixed with respect to rotation relative to the rotational axis A.

14. The torsional vibration damping arrangement according to claim 13, wherein the pressure storage comprises a second energy storage, wherein the second energy storage is an elastically deformable element or a pneumatically compressible element.

15. The torsional vibration damping arrangement according to claim 13, wherein the working medium between the displacer unit and the pressure storage is a viscous medium, a gas, or a combination of a viscous medium and a gas.

16. The torsional vibration damping arrangement according to claim 13, wherein the connection line has a rotary feedthrough, the rotary feedthrough rotatably connecting the displacer unit and the pressure storage so as to be liquid-tight and/or gas-tight and so as to be rotatable with respect to one another; and the displacer unit being rotatable around rotational axis A and the pressure storage being fixed with respect to rotation relative to the rotational axis A.

17. The torsional vibration damping arrangement according to claim 11, wherein the displacer unit comprises a load spring element, wherein the load spring element acts opposite a working direction of a change in volume V1 of the working chamber of the displacer unit.

18. The torsional vibration damping arrangement according to claim 11, additionally comprising a supply pump, a control unit, and a pressure storage having a working chamber and wherein the working chamber of the pressure storage is operatively connected to the supply pump and/or to the control unit.

19. The torsional vibration damping arrangement according to claim 12, wherein the stiffness arrangement of the damper subassembly comprises an energy storage constructed as an elastically deformable element or a pneumatically compressible element.

20. The torsional vibration damping arrangement according to claim 11, wherein the first energy storage between the primary inertia element and the secondary inertia element is an elastically deformable element or a pneumatically compressible element.
